(19) United States
(12) Patent Application Publication
(10) Pub. No.: US 2014/0260891 A1
(43) Pub. Date: Sep. 18, 2014

(54) CLAMP FOR A SAXOPHONE OR CLARINET MOUTHPIECE

(71) Applicant: Francisco Espinosa Ferrando, Ciudad Real (ES)

(72) Inventor: Francisco Espinosa Ferrando, Ciudad Real (ES)

(21) Appl. No.: 14/353,370

(22) PCT Filed: Jan. 10, 2012
(86) PCT No.: PCT/ES2012/000004

§ 371 Date: Apr. 22, 2014

(51) Int. Cl. G10D 9/02

(52) U.S. Cl. CPC G10D 9/02
USPC 84/383 R

(57) ABSTRACT

A clamp includes a flexible, interior conical component in contact with a barrel and a rigid, exterior conical component in contact with the interior component. The interior component has a longitudinal cut over its entire length and has, at the part that contacts the barrel, two central recesses. The exterior component acts on the interior component, and has the same conicity as the interior component. The exterior component prevents unwanted opening of the interior component by exerting a pressure on the interior component. Both components have a central recess, which form, as a whole, a mouthpiece resonating box that provides greater sound volume and different timbres, depending on the size of the recess and on the material from which it is produced. The flexibility of the interior component prevents breaking of the barrel even though three interior rings thereof are placed in different planes.

### OBJECT OF THE INVENTION

The present invention refers to a clamp for its use in connecting and holding the barrel to the mouthpiece in saxophones and clarinets.

The present invention discloses a clamp having two conical components: the inner component, which contacts the barrel and the mouthpiece, and the exterior rigid component, which embraces the interior flexible component, both components being manufactured from any type of material, or combination of materials, for use in those instruments which require the barrel and the mouthpiece to be connected. The interior component has, in its interior wall, closest to the mouthpiece and the barrel, two recesses in its central part, therefore having three interior rings: two at the ends and another one in the central part. The exterior component has a single recess in its interior central part, and it therefore has two conical rings in the ends in a single structure, one at the mouth of each cone.

Those recesses in the central part, in the case of the interior component, may have different dimensions depending on the desired tone.

### BACKGROUND OF THE INVENTION

The mouthpiece and the barrel, which are fundamental components of the musical instruments disclosed herein, saxophone and clarinet, must be used together forming a single body, a part of the barrel being permanently contacting the mouthpiece and the other part being free, allowing a certain degree of flexibility and, therefore, the entrance of air in the mouthpiece and the body of the respective instruments. Nowadays, metallic clamps are being used in these types of instruments, the necessary clamping pressure being obtained by means of a screw connecting the two halves of the clamp together, there being more than two contact points with the barrel.

The drawback with this clamp is that, in addition to the loss of sound, since there is no acoustic chamber, since there are more than two contact points with the barrel, which may not be in the same plane, breaks can occur, and they occur, and also circular displacements.

On the other hand, clamps formed by a single, conical, rigid piece holding the barrel to the mouthpiece by means of pressure with a certain risk of breakage are recently being used. Those having a recess in their central interior part do not pose that risk, but they can only be used with a specific barrel, so that every time a different barrel is used, the clamp must be replaced by a new one whose dimensions correspond to those of the former both in thickness and in width.

The clamp disclosed herein solves the two drawbacks: the breakage risk, since the flexibility of the interior component contacting the barrel applies the precise clamping pressure due to its own physical characteristics, and the loss of sound, since both the interior and the exterior components, in view of their morphology, act as an acoustic chamber.

### DESCRIPTION OF THE INVENTION

The two component clamp disclosed herein is made of any type of material, even each component may be made of a different material, depending on the desired tone or sound feature.

The interior conical component has a longitudinal opening all along its length that makes it flexible, allowing it to be adjusted to different barrels depending on their thickness and width. Its interior, where it contacts the barrel, has two central recesses forming three rings, one at each end and another one at the center, all three in the same plane, which result in two acoustic chambers, through which the sound cannot escape or be lost.

In addition, it has a ring in its exterior part, at the end located closest to the mouthpiece connector, for preventing the exterior component to exit or slide out.

The exterior component, also conical, is manufactured closed, having a central recess in the part which fits with the interior component, thus forming two rings, one at each end. The conical shape having the same axis inclination as the interior component, has as sole function preventing unwanted opening of the interior component and thus any unwanted movement of the same. Since there is also a central recess in its interior part, it also has an acoustic chamber.

### BRIEF DESCRIPTION OF THE DRAWINGS

FIG. 1. (page 1). The figure shows a view of the clamp assembly where a longitudinal cross section of the interior component is disclosed, and where the adjustment closure movements of the assembly are described.

FIG. 2. (page 2). The figure shows a view of the exterior adjustment and closure ring with the different movements.

FIG. 3. (page 3). The figure shows the interior component, where the exterior ring can be seen at the end closest to the mouthpiece connector, thus preventing the exterior component to be pushed out and allowing for installing the clamp with a single movement.

FIG. 4. (page 4). The figure shows the interior of the two components forming the assembly where the central recesses can be seen; this gives an idea of the different movements and the different ways of exerting pressure, either on the barrel or the interior component, or, although minimal, of the exterior component on the interior component.

1. Conical clamp having two component, a flexible, interior one having a longitudinal cut along its whole length and three interior rings and acoustic chamber, and additionally an external ring in the part closest to the mouthpiece connector, connecting the barrel to the mouthpiece by means of pressure, by sliding the exterior component, which is rigid and does not have any cut and two rings in its interior, one at each end, and acoustic chamber; for its use in connecting and holding the barrel to the mouthpiece in all types of saxophones, made in any type of material.
